(19) United States
(12) Patent Application Publication
(10) Pub. No.: US 2002/0111926 A1
(43) Pub. Date: Aug. 15, 2002

(54) Expert system

(76) Inventor: Alain Bebie, Zurich (CH)

Correspondence Address: Michael S. Neustel, Suite No. 4, 2534 South University Drive, Fargo, ND, 58103, US

(21) Appl. No.: 10/078,018

(22) Filed: Feb. 14, 2002

(30) Foreign Application Priority Data
Feb. 15, 2001 (DE) 101 07 928.1

(51) Int. Cl. G06N 5/00; G06F 17/00

(52) U.S. Cl. 706/45

(57) ABSTRACT

In order to create an expert system through which the solution requests, which are posed to the expert system, can be arranged in a simple and especially automatic manner, it is suggested that an administrative unit with a requester interface for communicating with solution requesters be provided, whereby the solution requesters can be connected to the administrative unit via a communication network, whereby further a provider interface for entering solution offers by the solution providers and a database are provided and in this database solution requests are stored in a given specification and solution offers are also stored with a given specification, whereby the administrative unit can carry out an analysis of solution requests and solution offers and on finding a possible solution of a solution provider on the solution request, the administrative unit establishes a contact between the solution requester and the solution provider.

### CROSS REFERENCE TO RELATED APPLICATIONS

The applicant hereby claims foreign priority benefits under Title 35, United States Code, Section 119 of German Patent Application No. 10107928.1 filed on Feb. 15, 2001. The German application is hereby incorporated by reference.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to expert systems and more particularly to an expert system consisting of an administrative unit with a requester interface for communication with those requesting solutions, an interface for the information provider and a database.

2. Description of the Prior Art

Expert systems are used to provide simple and clear access to specialized knowledge. Platforms can be built with the help of these systems to record, process and present complex dependencies in a clear manner.

### SUMMARY OF THE INVENTION

The basic task of this invention is to create an expert system with which the solution offers and solution requests sent to the expert system can be matched in a simple and especially automatic manner. According to this invention, this task is executed with the help of an expert system, which comprises an administrative unit having a requester interface for communication with solution requesters, whereby these solution requesters are connected to the administrative unit via a communication network; it also has an interface for information providers and a database in which solution requests are stored in accordance with the given specifications and in which solution offers are stored in accordance with the given specifications, in which it is possible to analyze solution requests and solution offers with the help of an administrative unit, which establishes a contact between the requester and the provider if as a result of such an analysis a probable solution for the request is found.

The expert system, which is the subject matter of this invention, first stores the solution requests and solution offers in accordance with the given specification, so that the search for solution offers for special solution requests is simplified. Since a requester is connected to the administrative unit via a communication network, anyone requesting solutions can generate solution requests. The administrative unit ensures that a specific format is present for requests and offers for the analysis of solution requests and solution offers and especially for filtering solution offers in accordance with solution requests.

Since the expert system arranges the contact between the solution provider and solution requester after a specific solution was searched for a specific request, the data traffic with reference to the solution provider and also the solution requester is restricted to the relevant cases of a possible development of a customer relation, i.e. the irrelevant cases are filtered out in advance.

This is done on the one hand by not arranging contact for unsuitable solution offers in case of solution requests and on the other hand the solution provider receives the request for a solution from the administrative unit in a defined format so that it can be easily verified whether there is a possibility of a relevant binding offer by the solution provider to the solution requester. For developing such a customer relationship knowledge of the expert system is required, whereby the expert knowledge of the expert system can get enhanced with solutions found for solution requests.

Due to this it is possible for the solution providers to provide their solution offers to the administrative unit in a definite manner within the framework of their abilities so that it can filter out possible relevant customers. The technical effort for the solution requester contact by the solution provider is thus minimized.

The expert system allows adaptations to special applications with reference to specialized knowledge stored in it so that the principle, which is the subject matter of this invention, can be applied to a number of application areas. For instance, the expert system operator can charge the solution provider for the contact of probable customers (solution requester). For this it can be foreseen that the solution requester can use the expert system free of cost.

Advantageously formulation of solution requests is moderated through the administrative unit. This helps in storing the solution requests in the database in accordance with the given specifications, in order to be able to execute the filtration of probable solution offers in a simple manner. It is especially advantageous if the administrative unit can execute the formulation of solution requests in an interactive manner to get user prompting while generating solution requests.

For this it can be foreseen that the administrative unit generates questions and especially specific questions for formulating a solution request for the user requesting a solution. The questions can be grouped together and/or multiple answer options can be provided. Favorably specified questions and/or rules for the formulation of solution requests are stored in a database. These specified questions and/or rules are regularly examined and updated by experts in order to be able to prepare optimized specification in each area of application.

Basically it is possible for the solution provider to transmit his solution offer to the administrative unit, for example through a storage medium. It proves to be especially advantageous, if the solution provider can be connected to the administrative unit via a communication network. He can then, for example update his offers, modify them or delete those offers that are no longer of interest.

It is positive if several solution offers are stored in the database. This provides solution requesters a choice of solution offers. Further it is an advantage if the administrative unit for simplifying the process of assignment between the offers and requests moderates the formulation of solution requests.

It is advantageous, especially, if the administrative unit can execute the formulation of solution offers in an interactive manner and/or the administrative unit provides the questions to the solution provider for formulating solution offers. The questions could be grouped together and/or multiple answers could be provided to achieve comfortable user prompting. Thereby it is advantageous when the specified questions and/or specified rules for formulating solution offers are stored in a database so that one can take advantage of the expert knowledge in the expert system.

It is convenient when the formulation of solution requests can be managed through the administrative unit in such a manner that the questions set by the administrative unit to the solution requester are dependent on the answers already provided by the solution requester. The questions set by the administrative unit can be single questions, a group of questions or for example questions with multiple answer options. The questions depend upon the rules stored. These rules can in-turn depend on the features that are already investigated, this means on valid answers already provided by the solution requester. This optimizes user guidance, because for example, questions, which make no sense in light of already received valid answers, can be dropped.

It is especially advantageous, when the solution requesters can be connected to the administrative unit within the framework of a Client-Server-Structure. Then the actual knowledge of the expert system is concentrated on the server, which encompasses the administrative unit. The clients (solution requesters) must have special software installed at the terminal end in order to be able to connect to the administrative unit. This facilitates monitoring and controlling of the access of the administrative unit by the solution requesters. On the other hand, such an access can easily be established via Intranet or Internet in a simple manner, so that basically any solution requester can connect to the administrative unit.

In order to maintain a high degree of efficiency of the expert system with reference to the communication between the solution requester and solution provider, it is favorable, if it is possible for the administrative unit to evaluate the solution offers. In this manner it is possible to pre-evaluate solution offers and especially groups of solution offers or variants of solution offers, before they are stored in the database.

This helps in excluding such solution offers right in advance. Thereby evaluation takes place especially on the basis of the rules already stored, which can refer to solution-offer-features already investigated into. Thereafter, solutions found to be valid are stored, that is, they are considered for a solution request while browsing for solutions, whereas inappropriate solutions are separated.

In the case of a variant of a design it is foreseen that a quality value is assigned to solution offers that have already been evaluated. This helps in quantifying “Solution-offer-quality”. This can be, for instance, used for reducing the time spent on browsing, whereby solution offers with a higher quality value are first searched for a solution request. Thereby quality value assignment is done especially on the basis of the rules stored in the database to enable specific quality value assignment.

Due to the same reason it is advantageous, when the solution providers can be connected to the administrative unit within the framework of a Client-Server- Structure. It is especially advantageous when the solution requesters and/or solution providers are connected to the administrative unit via the Internet as a communication network. A solution requester or a solution provider then needs only special access software and for example a modem as a technical support medium besides his terminal computer to be able to use the expert system.

As a matter of convenience, requester identification is stored in the database along with a solution request so that it is easier to match between a solution provider and a solution requester, in case a relevant solution offer for a solution request was filtered out. Due to the same reason it is advantageous to store provider identification with a solution offer in the database.

As a matter of convenience, solution offers are stored in the database in the form of features and/or feature conditions to be able to check the features/feature conditions in case of a solution request with a given specification and to understand as to how far the solution offer is of any relevance for a solution request.

It is especially advantageous, when the administrative unit filters solution offers for a solution request, i.e. it rejects all irrelevant solution offers for a solution request within the framework of predefined rules and presents only the relevant solution offers to the solution requester. Thus it is convenient when the administrative unit presents the solution requester only suitable offers and sets aside unsuitable offers during the presentation. Advantageously, the administrative unit informs the solution requester about suitable solution providers so that he can cancel out specific providers with whom he does not want to place any request. Through communication set up by the administrative unit a solution requester can pose questions and inquiries to a solution provider.

It is of great advantage when the requests are transferred to the administrative unit and from there they are transferred to a suitable solution provider, i.e. when the “first contact” between a solution requester and a solution provider does not develop as a direct contact, but the administrative unit initiates it (“Matchmaking”). Then the solution provider receives a relevant solution request in a specified format so that he can decide in a simple and quick manner, whether or not he would like to have contact with the solution requester. It is convenient when a request to a solution provider displays a certain specification.

In order to make it possible for the solution requester to take a decision, he can advantageously explicitly exclude a solution provider to prevent transfer of solution requests to specific solution providers through the administrative unit. Further it is convenient when a solution provider can offer a solution to the solution requester for his specific request, as far as the solution provider so desires. Especially the solution provider and solution requester can be connected via a communication network and solution provider and solution requester can be connected via the Internet in a Client-Client-Relation. The real communication between the solution provider and the solution requester for developing a contractual relationship takes place independent of the administrative unit, which has only established a contact between them.

Advantageously, the process of filtering out suitable solutions takes place in accordance with the specified facts and/or specified rules. The expert knowledge of the expert system comes into the picture at this point, which applies the information it has on a specific area of application for filtering. The most relevant information in an area of application flows into certain specifications, in which the solution requests and solution offers are stored in a database.

Especially, solutions found in the database are stored with a corresponding provider-identification. Due to this, there is specialized knowledge in the database, which has solution offers for solution requests stored in it, whereby the solution provider or solution providers can be identified because of provider-identification.

In case of a variant of a design it is provided that solution requests are stored in the database. Therefore it is possible, for example, to evaluate solution requests statistically, in order to obtain information on the usage of the expert system. Due to this it is also possible to present information to the solution providers about the issues and requirements of the market, so that they can adapt or supplement their offer and product range.

It is especially advantageous, when the administrative unit has an interface for one or more specialists. This enables the specialists, who have specialized knowledge in the area of application for which the expert system is being used, to optimize the system and also to introduce their knowledge and similar things into the system. As a matter of convenience, one or more specialists can connect to the administrative unit via a communication network, for instance within the framework of a Client-Server-Structure to optimize the system in a decentralized manner. As a mater of convenience the specialists can store the solutions in the database. For certain solution requests like “simple” solution requests the specialists can then generate and communicate the solution directly.

It is especially favorable, when the specialists can specify questions and/or rules for formulating and/or storing solution requests. This facilitates the process of optimization of the expert system for a particular area of application. Further it is advantageous, if the specialists can specify questions and/or rules for the formulating and/or storing of solution offers to optimize communication of solution requests and solution offers.

As a matter of convenience, the specialists can specify rules for filtering solution offers for a solution request. It is further convenient when the offers stored in the database can be transferred to the specialists. This enables the specialists to check the expert system for its efficiency and modify it if need be.

It is also convenient that the results of the solution requests for solution-offer-assignments can be communicated to the specialists. Through this, the specialists receive qualitative and/or statistical statements with reference to the assignment success of the expert system, through which it can be further modified.

The task mentioned at the outset is further executed through a procedure for assigning solution offers to the solution requests, whereby the administrative unit communicates with the solution requesters via a requester interface via a communication network and for which a database is provided, in which solution requests are stored in accordance with the given specification and in which solution offers are stored in accordance with the given specification and for which analysis is carried out by the administrative unit for solution requests and solution offers and as a result of such an analysis, if a solution for the request of a requester is found, then the administrative unit establishes a contact between the solution requester and solution provider.

This procedure also displays the advantages that have already been mentioned in the context of the expert system, which is the subject matter of this invention. Further advantageous designs have already been explained in the context of the expert system, which is the subject matter of this invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a schematic presentation of the structure of an example of implementation of the present invention.

FIG. 2 is a block graph through which functioning of the expert system has been explained.

FIG. 3 is a schematic presentation in the form of a flowchart of a form of implementation of analysis and of recording solution requests by the expert system, which is the subject matter of this invention.

FIG. 4 is a schematic presentation in the form of a flowchart for recording of solution offers by the expert system.

FIG. 5 is a schematic presentation in the form of a flowchart for filtering solution offers for a solution request.

FIG. 6 is a schematic presentation in the form of a flowchart for presentation of solutions by the expert system to the solution requester.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

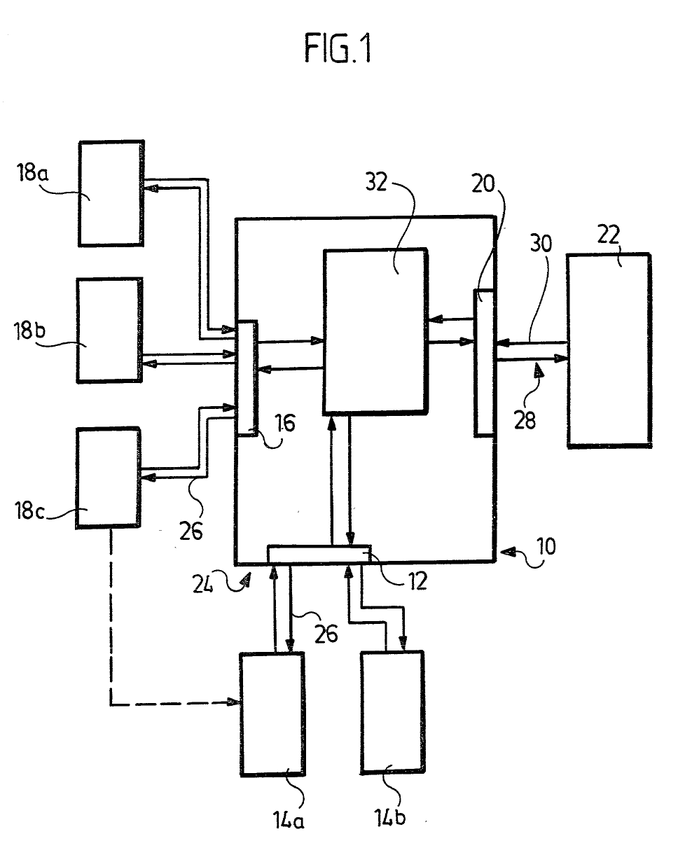

An implementation example of the expert system, which is the subject matter of this invention, which is shown in FIG. 1 schematically using a flowchart, encompasses an administrative unit 10. This has a requester-interface 12, for communicating with the solution requesters 14a, 14b etc. Further it displays a provider-interface 16, for communicating with solution providers 18a, 18b, 18c etc.

In case of the variant of the implementation example the administrative unit 10 also encompasses a specialist interface 20 for communicating with one or several specialists 22. Communication of the administrative unit 10 with the solution requesters 14a, 14b takes place via a communication network, which is indicated with 24 as a whole. A communication link 26 between a solution requester, for example 14a, and the administrative unit 10 is bi-directional, i.e. data can be exchanged in both directions: The administrative unit 10 not only receives but also sends data and the solution requesters 14a, 14b can send as well as receive data.

It is specifically provided that the solution requesters 14a, 14b can be connected to the administrative unit 10 in a Client-Server-Structure, whereby the administrative unit 10 represents a server and the solution requesters its respective clients. The communication network 24 can for example represent an Intranet. It is of great advantage if the communication network 24 is connected to the Internet. Basically this makes it possible to establish a connection between every potential solution requester with the administrative unit 10.

It can be foreseen that the solution requesters 14a, 14b can connect to the administrative unit 10 only via a password or special communication software at the terminal end to especially ensure that only identifiable solution requesters communicate with the administrative unit 10. The solution requesters 14a, 14b must have relevant special devices at the user end especially input devices, display devices and modem to be able to communicate with the administrative unit 10.

A solution provider can communicate his solution offers to the administrative unit basically via a storage medium. Advantageously, the solution providers 18a, 18b, 18c etc. are in contact with the administrative unit 10, optionally or additionally, via a communication network like the Internet. Likewise, a specialist 22 can be in contact with the administrative unit 10 via a communication network 28 in order to be able to communicate with it. Thereby it is also the case of a bi-directional connection 30, through which exchange of data between the specialist 22 and the administrative unit 10 is possible. For example a specialist 22 has Intranet and/or Internet access to the administrative unit 10.

The administrative unit 10 includes a database 32. Solution requests and solution offers are stored in this database 32 according to a certain specification, as well as the requester-identification and provider-identification. For this purpose, the database 32 is connected to the respective interfaces 12,16, 20. In addition to this, solutions/offers for solution requests are stored in the database. Furthermore, questions and rules are stored in the database 32, which are used to bring the solution requests and solution offers in their respective specifications and save them. Rules and facts are also stored in the database 32, which are used to carry out an analysis of solution offers with respect to the solution requests to filter out suitable solution offers and communicate them to the solution requester. As explained below, via the administrative unit 10 the requester identification can be communicated to the solution provider if a suitable offer is found, so that the solution provider (in FIG. 1 18c) can directly contact the solution requester (in FIG. 1 14a) and can transfer a concrete offer to his request (to the administrative unit 10). The communication between the solution requester 14a and the solution provider 18c takes place after communicating through the administrative unit 10 directly as Client-Client direct contact via Internet. Thus the administrative unit 10 creates a sort of “Matchmaking” between a solution requester 14a and a solution provider 18c, whereby the solution provider 18c was identified by the administrative unit 10 for the request of the solution requester 14a.

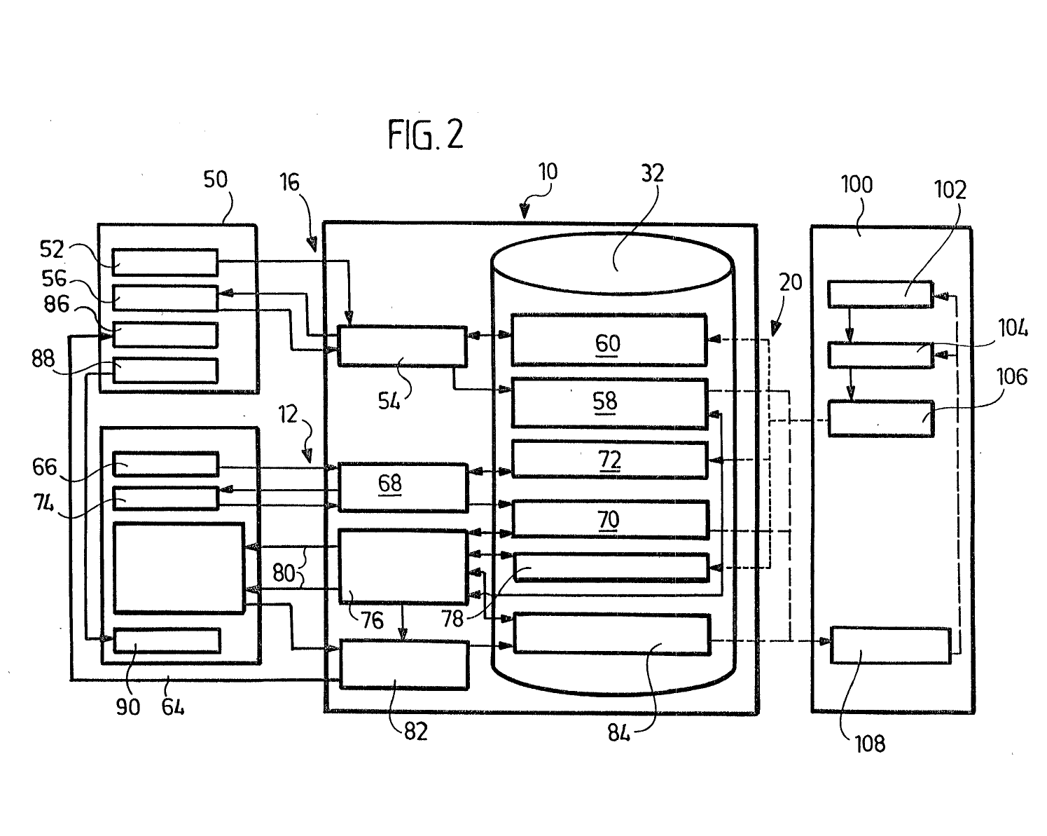

As the solution requester communicates with the administrative unit 10 only via interface 12 and the solution provider communicates only via interface 16, its access is easy to control. The expert system, which is the subject matter of this invention, functions as follows as explained in FIG. 2. A solution provider 50 transfers one or several solution offers to the administrative unit 10. This takes place whereby the relevant data is read, for example, via a storage medium in the database 32 of the administrative unit 10 where the solution offers are already present as per the given specification. It can also be arranged optionally or additionally that the solution provider 50 activates the expert system using locally installed software via the Internet and gets connected with the administrative unit 10 via the provider interface 16. This activation is marked with the reference sign 52 in the figure. The administrative unit moderates the data entry by the solution provider 50 using a detection module 54 by way of a detection process to bring the solution offers with the given specification, in which they can be stored in the database 32. Thereby, the solution offers with the given specification can be present in the form of features, which were raised accordingly, and probably in the form of conditions between the features (feature conditions). It can be specifically foreseen that the features are arranged in order of hierarchy. During the process of detection, the features are to be verified and recorded accordingly.

For this purpose, the administrative unit 10 poses specific questions to the solution provider 50 during the process of detection, which the solution provider must answer. This is clearly indicated in FIG. 2 with a reference sign 56. Thus, the solution provider 50 can communicate in an interactive manner with the administrative unit 10 for detecting solution offers to obtain user prompted solution offers in a given specification. Solution offers thus obtained with the given specification are stored in database 32 in the solution-offers-memory 58, and in fact especially in the form of features and feature conditions. Along with the solution offers, the respective provider-identification is also stored to assign a solution provider to a solution offer at a later stage. It can also be arranged that a quality value be assigned to the solution offer using the stored rules, i.e. the solution offer is evaluated by the expert system. This enables a hierarchical arrangement of solution offers to run a search for a solution request at a later stage, i.e. solution offers with a high quality value are browsed first and then solution offers with a low quality value.

The database 32 displays identification memory 60, in which the rules are stored, according to which the solution offer is to be brought into the predefined specification, i.e. finally the given specification is stored. Further corresponding questions are stored, which are to be posed to the solution provider 50 during the detection process 54 to obtain user prompted (moderated) solution offer detection. A solution requester 64 activates the expert system that is the subject matter of this invention, with the process of activation 66 via communication network 26 and especially the Internet, whereby it communicates with the administrative unit 10 via interface 12.

For this purpose the administrative unit 10 includes a solution-request-detection unit 68, which records the solution requests of the solution requester 64 and transfers them to the solution request memory 70 of the database 32. In order to find a suitable solution offer for a solution request, the solution requests must be stored according to the given specification in the solution requests memory 70. For this purpose, the database 32 has a registration memory 72 for solution requests, in which rules are stored to bring the solution requests in such a form that they fulfill the given specification. Further questions are stored in the identification memory 72, which are posed to α solution requester 64 by the solution requests identification unit in order to control the registration of a solution request on the one hand and on the other hand to be able to carry out an analysis of the requirement or the problem, which is at the base of a solution request. Along with a solution request, solution requester identification is also stored in the solution requests memory 70 to identify a solution requester. Based on the specified rules and questions, the solution requests identification unit 68 communicates with the solution requester 64 through a controlled and optimized interactive questioning and analysis process 74. If a solution requester 64 terminates the input of a solution request, wherein the solution request was stored in the solution requests memory 70 as per the specification, then the process of filtering can be initiated according to which such solution offers are filtered out that are suitable for the solution request and are communicated to the solution requester 64, if necessary.

It can be also so arranged that the solution requests are stored and are statistically evaluated in order to offer a possibility to the solution providers to adapt their solution offers as per the problems and the requirements of the solution requesters. Further, the administrative unit 10 includes an analysis unit 76 through which one can filter out solution offers suitable for a solution request and present them to the solution requester 64. For this purpose, the solution requester unit 64 is connected to the solution request memory 70 and solution offer memory 58 and can specifically read data from these two memories and execute a process of comparison.

For filtering and evaluating the extent of suitability of a solution offer and to reply to a solution request, relevant facts and rules for the proper evaluation of a solution request must be specified. For this purpose, a rule memory 78 is provided, in which relevant facts and rules for the evaluation of solution offers for a solution request are stored. Thereby, this rule memory 78 is connected to the analysis unit 76, so as to enable it to execute filtration and evaluation processes.

Further, rules for presentation of valid solution offers are stored in the rule memory 78 of the database 32 so that the analysis unit 76 can transfer a solution offer, which it has evaluated against the solution request from a solution requester 64, in the form of a presentation (reference sign 80). The software, which was installed as a part of the expert system with the solution requester 64, has a request module in case of a variant of this design, using which the solution requester 64 can communicate with the administrative unit 10 via the interface 12 that it should inquire with one or more solution providers, whereby these solution providers, to whom a request is to be transferred, can be specifically selected from the number of solution providers communicated by the analysis unit 76.

The administrative unit 10 has a request module 82, which cooperates with the interface 12. The solution requester 64 communicates his agreement on an inquiry to a solution provider and his choice of solution providers to the request module. For storing filtered solution offers for a solution request, about which the expert system is of the view that there is enough agreement between the solution request and the solution offer, a solution memory 84 of the database 32 is provided. This solution memory 84, in case of a variant of this design, is connected to the analysis unit 76 as well as to the request module 82. Solutions along with the solution provider identification are stored in the solution memory 84 and in fact in accordance with the filtration done by the expert system; by the analysis unit 76 and the subsequent further selection by the solution requester 64.

Thus, the solutions detected for requests are stored in the solution memory 84. Due to the stored provider identification, a provider can be assigned to a solution request in the solution memory 84. Sensibly, the analysis unit 76 checks the solution memory 84 for a request, to check whether a solution offer already exists for a solution request. It can also be provided that the administrative unit 10 has a memory for solution requests, to which a solution offer could not be assigned. While accessing the solution offers once again it can be checked whether suitable solution offers haven't already been entered for the open solution requests.

Thereafter, the request module 82 transfers a solution request that was found out by the expert system to the solution provider 50, who was not excluded explicitly by the solution requester 64. Thereby, the solution request communication of the administrative unit 10 to the request module 86 of the solution provider 50 takes place in a definite request-specification so that the solution provider receives the solution request in a specific format, which simplifies his task of working out a concrete offer to the solution requester 64 as a potential customer.

Then the solution provider 50 can generate an offer (reference sign 88) and can send it to the solution requester 64 in Client-Client-Connection, for example, via the Internet, whereby the solution requester 64 receives the offer (reference sign 90). In this manner, the Provider-Customer-Relation is established, whereby the expert system on the one hand supports request detection in the sense of problem recognition/request recognition and on the other hand finds out suitable solution providers. Moreover, the expert system 10 takes care 30 that a provider does not receive diffused “requests”, but receives them only as per a definite specification, since they are transferred by the administrative unit 10 to the solution provider, and really only, when the solution provider was recognized as an appropriate provider. The administrative unit 10 also looks after “Matchmaking” between a solution requester 64 and a suitable solution provider 50, whereby they are matched with each other by the expert system

The administrative unit 10 is in further contact with one or more specialists 100 via a specialist interface 20. The specialist 100 has theoretical and/or practical expert knowledge 102 in the field, in which the expert system, which is the subject matter of this invention, is being specially used. Furthermore, the specialist looks after system preparation and/or system optimization of the expert system 104 and accordingly introduces his knowledge into the system. This has the effect that a specialist using a default module 106 can record questions, solutions, rules and the likes into the administrative unit 10 and in fact specifically the identification memory 60 for the offer identification, the identification memory 72 for request identification and the rules memory for filtration of suitable solution offers for a solution request.

As matter of convenience, the connection of the specialist 100 with the administrative unit 10 can be bi-directional, i.e. the specialist optimizes the expert system with respect to the solution offers already entered, solution requests already entered and the solutions found. For this it is connected to the solution offer memory 58, solution request memory 70 and solution memory 74 via a recognition module 108. The recognition module can then record the information from statistical and/or qualitative evaluations, which contribute to knowledge expansion and help with system preparation and system optimization.

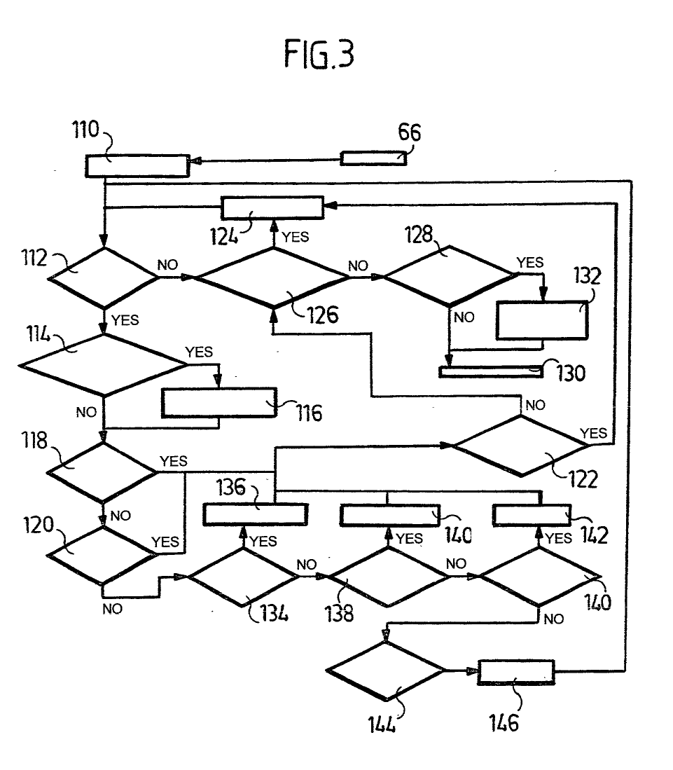

With the help of FIG. 3, for example, using a flowchart, it is shown schematically as to how a request dialogue for the identification of solution requests develops under the control of the administrative unit 10: The system is started (reference sign 66). The specification of a solution request, according to which it is stored in the solution requests memory 70, for example includes a number of data records according to the elements arranged in a hierarchy. Analysis elements are assigned to these elements, whereby the solution request detection unit 68 inquiries these elements and data that exist in connection with these elements.

These elements could be control elements, computation elements, reply options, questions, groups of questions or topic groups. The solution requests unit 68 refers to the first analysis element to be inquired (reference sign 110). After that the validity of the element is checked (reference sign 112). The validity test is done as an example on the basis of rules assigned, which can be related to already known facts.

In positive cases, in which the element was recognized to be valid, it is checked, whether the element was the last in the group of questions (reference sign 114). If this is approved, then a “complete” question is presented, which can be communicated to the solution requester 64 in the form of a communication text 116, whereby the question is recorded in a web-file, communicated and the answer is then recorded. If during the examination 114 it was found out that the element is not the last one in a group of questions, then the further examination step 118 checks, whether the element is a group theme. If this test is negative, then further examination 120 is conducted to see whether the element is a group of questions.

If the examination step 11 8 or 120 gives a positive result, then with examination step 122 it is checked whether the element is at a lower level in the hierarchy. If the case is positive, then the system positions itself at this element (reference sign 124) and gets into the validity test 112, i.e. it is verified, whether the element, which is at the lower level in the hierarchy, is a valid element.

If the examination 122 shows that the element is not at a lower level in the hierarchy, then the immediate next element is examined to see whether it is at the same or a higher level in the hierarchy of elements. This examination step has a reference sign 126 in the FIG. 3. If the test 126 is positive, then in the monitoring step 124 the system positions itself at the consecutive element.

If on the contrary, the test 126 is negative, then it is further examined, whether the web-file to be sent to the solution requester 64 is still attached (reference sign 128). If this is not the case, then one can start with evaluation 130. If on the contrary, the web-file to be sent is still pending, then it is sent to the solution requester 64 and his reply is recorded (reference sign 132).

If the test 120 is negative, which was conducted to see whether the element was a group of questions, then the test step 134 is initiated to see whether the element is a question. If the case is positive, then the question is inserted into the web-file, which is sent to the solution requester 64 (reference sign 136). The insertion step is followed by test 122. If the test 134 is negative, i.e. the element is neither a group theme, a group of questions nor a question, then in step 138 it is verified, whether the element is a replay option. If the case is positive, then the replay option is added in step 140 to the web-file to be sent and the system takes up test 122.

If the outcome is negative, further test 140 is conducted to see whether the element is a computation element. If the case is positive, i.e. if the element is a computation element, computation is performed in step 142 and the system transfers further to the test step 122. If this test is negative, then it is finally checked whether the element is a control element (reference sign 144). If the elements are specified in such a manner that when all other element tests are negative, the element could only be a control element, then this test must be positive and then through the control element the system positions itself at the target element specified by the control element (reference sign 146) and then step 122 is carried out again for the validity check of the element.

As explained in the example, the proposed hierarchy structure of elements on the one hand helps to record a solution request of a solution requester 64 in a definite specification and at the same time, the solution request can be analyzed, i.e. the problem/requirement of the solution requester is analyzed. This in-turn takes care that the solution request is stored in the solution requests memory 70 in a specific format, in order to be able to assign probable solution offers to the solution request.

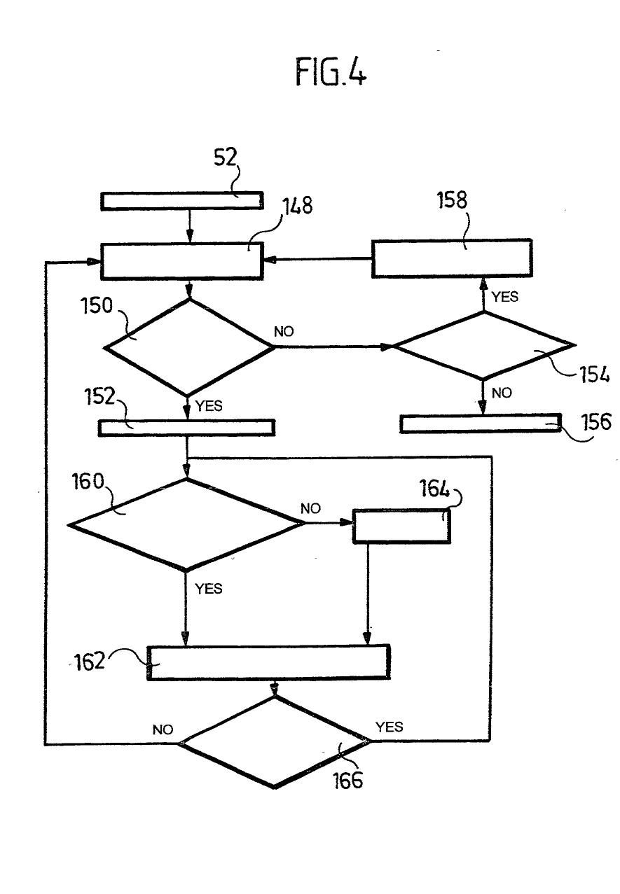

The example in FIG. 4 shows how the offers can be recorded by the administrative unit 52. In database 32 a specific list 148 of possible offers is already stored and after the solution provider 50 has activated 52 the system, it is possible for him to select an offer from the list 148, i.e. he checks through an inquiry 150, whether the solution offer is to be found in the list 148 and selects the relevant offer from the list, if his search is positive (selection step 152).

If the search is negative, then the solution provider 50 has the possibility 154 of adding an additional offer to the list. If the solution provider 50 does not wish to do so, then the process of offer detection is terminated (reference sign 156); otherwise the additional offer is added to the list of new offers (reference sign 158). After the solution provider 50 has selected the solution offer 152 he can make the offer more precise by using suggested formulae, with which offer elements can be combined, for example numeric formulae or formulae based on Boolean Algebra. This selection step results into a determination 162 for example of limit value parameters with corresponding limit values, by which the offer can be made more precise.

The solution provider 50 can redefine 164 the formulae and similar things to execute the determination 162. From the determination step 162 it is further checked with the test step 166, whether the provider would like to execute further combinations. If the outcome of this is negative, the system goes back to the display of the list of possible offers and the solution provider 50 may terminate the offer input. In case the outcome is positive, the solution provider can select further formulae and similar things though the selection step 160.

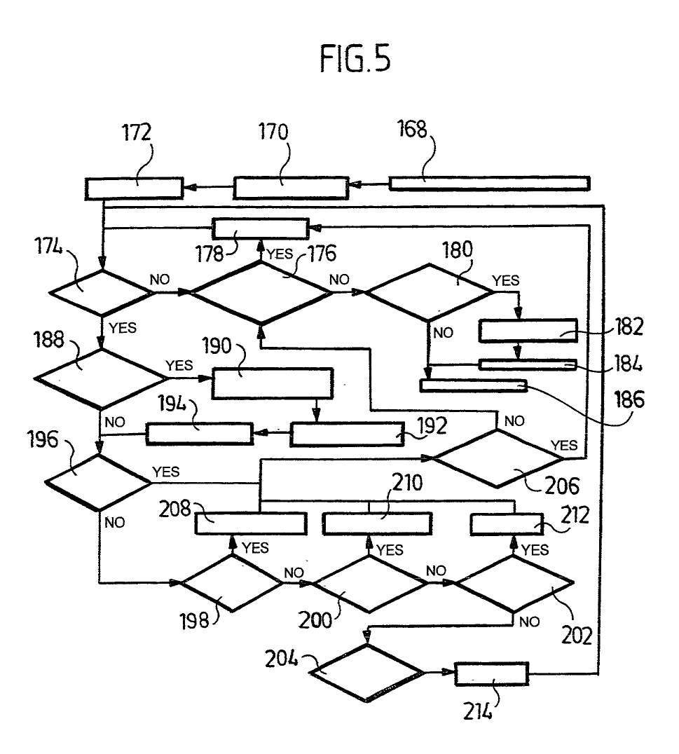

For a variant of this design, the execution of evaluation for searching has been described in FIG. 5 with the help of an example: After a start 168 of the process of evaluation, for example, the web-file is opened in step 170, in which all matching solution offers for a solution request are listed.

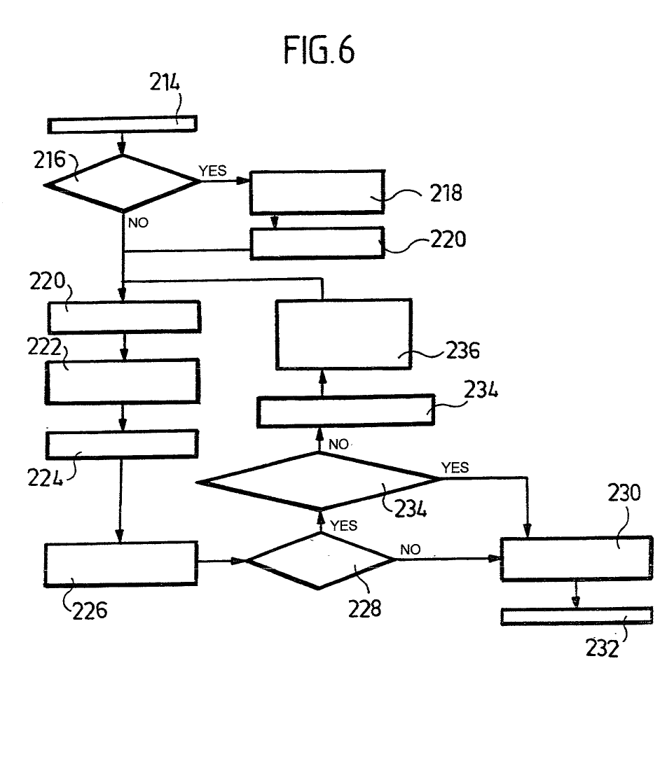

In step 172 the system positions itself at the first solution element and then with test step 174 it is verified whether the element is valid. If the outcome is negative, a further test step 176 is executed to see whether the following element is at the same level or higher level of hierarchy. If this test is positive, then the system positions itself at this element 178. If the test 176 is negative, then with a test step 180 it is verified, whether the web-file to be sent is still pending. If the outcome is positive, suitable solution providers are listed down in the web-file (reference sign 182). After this the web-file is closed (reference sign 184) and is transferred for presentation 186 (compare FIG. 6). If test 180 is negative; if no web-file is pending, then the system directly goes to the presentation 186.

If the test step 174 for the validity of the element shows that it is valid, then with test 188 it is examined, whether the element is the last one in the hierarchy. If this test is positive, then the solution providers 50 are accordingly selected, for example, on the basis of product features and requirement features in accordance with the respective elements (reference sign 190). Relevant solution providers 50 are recorded in the web-file in a listing step 192 and the web-file is closed (reference sign 194) and a new web-file is opened if necessary, provided not all possible solutions were recorded in this web-file or the Web-files described earlier.

If test 188 shows that the element is not the last one in the hierarchy, then further tests are carried out maintaining the sequence of hierarchy. Starting with test 196 it is further verified, whether the element is a group theme, whether the element is a solution reference sign 198), whether the element is a solution feature (reference sign 200), whether the element is a computation element or whether the element is a control element (reference sign 204).

If test 196 is positive, the test step 206 is executed to see whether the element is at a lower level in the hierarchy. If the case is positive, then the system positions itself at this element, i.e. the system takes up the positioning step 178. If the outcome is negative, a further test step 176 is executed to see whether the following element is at the same level or higher level of hierarchy.

If test 198 is positive, then the solution offer is recorded in the web-file (reference sign 208) and then test 206 is conducted. If test 200 is positive, then the solution offer is recorded in the web-file (reference sign 210) and then test 206 is conducted.

If the element is a computation element, i.e. if test 202 is positive, then computation is done (reference sign 212) and then the system takes up test 206. If the element is finally a control element, then according to the control specifications, the system positions itself at the target element in step 214 so that the position step 178 is attained.

An example of the presentation of solutions to a solution requester 64 is shown with the help of FIG. 6: After the presentation is started (214), with the test step 216 it is checked, whether more than one web-file was created during the analysis, for example as shown in FIG. 5. If yes, then information is attached to the web-file that still more solutions exist (step 128). Then the system positions itself at the first solution web-file in step 220. If only one web-file is present, then it is sent to the solution requester 64 in step 220. If necessary, further information, like for example picture sequences or the likes, is sent to the solution requester 64 in step 222 with the aim of providing him with detailed information about the solution offer found and its corresponding provider.

In a waiting step 224, the system waits for the reply from the solution requester. Meanwhile, the solution requester can choose possible solution providers and can authorize the notification to one of the solution providers found. Thereby a registration 226 of the solution provider authorized by the solution requester is done.

It is once again verified with test step 228, if more than one web-file is present. If not, then the solution request is sent in the step 230 in the definite specification to the selected solution provider selected by the expert system and if required by the solution requester 64. After this the transmission activity of the system for this special solution request comes to an end (reference sign 232). If test 228 shows that there are more than one web-files, then with step 234 it is verified whether the solution requester 64 has communicated to terminate the process, i.e. no more solution offers should be communicated to the solution requester 64. In this case, the send process 230 is released.

If the solution requester 64 has not communicated that the process should be terminated, then the system with step 234 goes to the next selected solution web file and with the further step 236 the web-file selected in step 234 is marked “next solution” and/or the previous web-file is marked “previous solution” logically. Likewise, a marking “terminate” is provided so that the solution requester can abort the selection process of solution offers. Beginning with step 236, the relevant web-file is transmitted to the solution requester 64 in sending step 220.

I claim:

1. An expert system, comprising an administrative unit with a requester interface for communicating with solution requesters via a communication network, a provider interface for identification of solution offers by solution providers, and a database in which solution requests are stored according to a given specification and in which said solution offers are stored with a given specification, for which said administrative unit can perform an analysis of said solution requests and said solution offers and as a result of such an analysis, when a possible solution of a solution provider is found for said solution request, establish a contact between a solution requester and a solution provider.

2. The expert system according to claim 1, wherein a formulation of said solution requests is managed by said administrative unit.

3. The expert system according to claim 1, wherein a formulation of solution requests with said administrative unit is interactive.

4. The expert system according to claim 1, wherein said administrative unit presents a solution requester with questions for the formulation of a solution request.

5. The expert system according to claim 4, wherein said questions and given rules for the formulation of solution requests are stored in said database.

6. The expert system according to claim 1, wherein the formulation of said solution requests by said administrative unit can be moderated in such a manner that the questions set by said administrative unit to the solution requester depend upon the answers already given by said solution requester.

7. The expert system according to claim 1, wherein said solution offers are stored in said database.

8. The expert system according to claim 1, wherein a solution provider may be connected to said administrative unit via a communication network.

9. The expert system according to claim 1, wherein the formulation of solution offers requests is managed by said administrative unit.

10. The expert system according to claim 1, wherein the formulation of said solution offers with said administrative unit may be done interactively.

11. The expert system according to claim 1, wherein said administrative unit presents a solution provider with questions for the formulation of solution offers.

12. The expert system according to claim 1, wherein given questions and given rules for the formulation of said solution offers are stored in said database.

13. The expert system according to claim 1, wherein said solution offers are evaluated by said administrative unit.

14. The expert system according to claim 13, wherein a quality value is assigned to the evaluated solution offers.

15. The expert system according to claim 14, wherein said quality value is formulated based upon rules stored in said database.

16. The expert system according to claim 1, wherein said solution requesters can be connected to said administrative unit within the framework of a client-server-structure.

17. The expert system according to claim 1, wherein said solution providers can be connected to said administrative unit within the framework of a Client-Server-Structure.

18. The expert system according to claim 1, wherein said solution requesters can be connected to said administrative unit via the Internet via a communication network.

19. The expert system according to claim 1, wherein said solution providers may be connected to said administrative unit via the Internet via a communication network.

20. The expert system according to claim 1, wherein a requester identification along with a solution request is stored in said database.

21. The expert system according to claim 1, wherein a provider identification along with a solution offer is stored in said database.

22. The expert system according to claim 1, wherein said solution offers are stored in said database in the form of features and feature conditions.

23. The expert system according to claim 1, wherein said administrative unit filters solution offers to a solution request.

24. The expert system according to claim 23, wherein said administrative unit presents the solution requester with suitable solution offers.

25. The expert system according to claim 24, wherein said administrative unit presents a solution requester with suitable solution providers.

26. The expert system according to claim 25, wherein said solution requester can send inquires to said solution provider on the presentation of said solution offers.

27. The expert system according to claim 26, wherein said inquiries are first transferred to said administrative unit and then forwarded to an appropriate solution provider.

28. The expert system according to claim 27, wherein a request to a solution provider is set up according to a definite specification.

29. The expert system according to claim 28, wherein a solution requester may explicitly exclude a solution provider.

30. The expert system according to claim 29, wherein a solution provider can communicate an offer to the solution requester upon specific request.

31. The expert system according to claim 1, wherein said solution provider and said solution requester can be connected via a communication network.

32. The expert system according to claim 3 1, wherein the solution provider and the solution requester can be connected via the Internet in a client-client-relation.

33. The expert system according to claim 32, wherein a process of filtering of suitable solutions takes place according to given facts and given rules.

34. The expert system according to claim 33, wherein said solutions found are stored in said database along with an assigned provider identification.

35. The expert system according to claim 1, wherein said solution requests are stored in said database.

36. The expert system according to claim 35, wherein said solution requests are statistically evaluated.

37. The expert system according to claim 1, wherein said administrative unit has an interface for one or more specialists.

38. The expert system according to claim 37, wherein said one or more specialists can be connected to said administrative unit via a communication network.

39. The expert system according to claim 38, wherein said one or more specialists can store solutions in said database.

40. The expert system according to claim 39, wherein one or more specialists can specify questions and rules for formulation and storage of said solution requests.

41. The expert system according to claim 40, wherein said one or more specialists can specify questions and rules for formulation and storage of said solution offers.

42. The expert system according to claim 40, wherein said one or more specialists can specify rules for filtering of solution offers for a solution request.

43. The expert system according to claim 42, wherein said one or more specialists can receive offers stored in database.

44. The expert system according to claim 43, wherein said one or more specialists can receive requests stored in database.

45. The expert system according to claim 44, wherein said one or more specialists can receive results of solution request and solution offer matching.

46. A method for assigning solution offers to solution requests, said method comprising the steps of:
(a) an administrative unit communicates with said solution requesters using a requester interface via a communication network;
(b) said solution requests are stored with a given specification;
(c) said solution offer s are stored with a given specification;
(d) said administrative unit analyzes said solution requests and said solution offers; and
(e) upon finding a possible solution of a solution request by a solution provider, said administrative unit establishes a contact between said solution requester and said solution provider.
